(19) United States
(12) Patent Application Publication
(10) Pub. No.: US 2010/0234113 A1
(43) Pub. Date: Sep. 16, 2010

(54) ROTARY LEAD-THROUGH FOR SUPPLYING OIL TO A TRANSMISSION SHAFT COMPRISING AN AXIALLY EXTENDING BORE OR OIL PASSAGE

(75) Inventors: Michael Drabek, Brandenburg (DE); Uwe Beer, Potsdam (DE); Jens Patzner, Potsdam (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/676,159

(22) PCT Filed: Sep. 11, 2008
(86) PCT No.: PCT/EP2008/062027

§ 371 Date: Mar. 3, 2010

(30) Foreign Application Priority Data
Sep. 18, 2007 (DE) 10 2007 044 518.2

(51) Int. Cl. F16N 1/00

(52) U.S. Cl. 464/7

(57) ABSTRACT

A rotary feed-through is proposed to supply oil to a transmission shaft (1), in an axial extending borehole or oil passage (2), respectively, comprising a stator, positioned at the enclosure, and a rotor, turning with the shaft, in which the bearing cover (4), connected with the enclosure, or the holding plate of the bearing (3), respectively, of the shaft (1) which needs to be supplied with oil, serves as a stator, and the hub (6) of an already present part (5), axial viewed at the side of the bearing (3), facing away from the enclosure and positioned before the bearing (3), and rotationally linked torque-free with the shaft (1), serves as the rotor of the rotary feed-through.

This application is a National Stage completion of PCT/EP2008/062027 filed Sep. 11, 2008, which claims priority from German patent application serial no. 10 2007 044 518.2 filed on Sep. 18, 2007.

### FIELD OF THE INVENTION

The present invention relates to a rotary feed-through to supply oil to a shaft of a transmission comprising an axially extending borehole or oil passage, respectively.

### BACKGROUND OF THE INVENTION

Shafts which have an axial extending borehole or oil passage, respectively, are often used to guarantee a lubricating oil supply for parts, when the supply becomes difficult through other methods. For instance, it can apply to the lubricating oil supply to an idle gear bearing. As known in the art, the oil is pressed, by means of a rotary feed-through, into the enclosure boreholes, or slots, respectively, extending into the rotating shaft, whereby, and for this purpose, usually a rotating shaft slot is provided which has radial boreholes towards the inner shaft. Slip ring seals are also provided to seal the rotary feed-through, usually designed as rectangular ring seals, which can be positioned in the associated rectangular ring slots.

An oil lubrication system for a transmission is known by DE 32 38 780 C1 in which a centrifugal pump is used which guides the oil to the outside, through breakouts into a redirecting duct. Hereafter, the oil can flow into the inner part of the hollow drilled transmission shaft via a circular notch. Although this system guarantees an effective lubricant oil supply, it has the disadvantage that the necessary centrifugal pump requires space and sealing is not available in all cases.

Also, the applicant knows about an oil lubrication system for transmissions, by DE 195 01 799 C2, comprising a ring shaped chamber into which the lubrication oil and cooling oil is provided, a rotating transmission shaft, and a conveying element for the lubrication oil and cooling oil, whereby at least one axially offset lubrication oil borehole is provided in the rotating transmission shaft, and whereby the conveying element is designed as a catch and guide plate, which is firmly connected with the transmission enclosure, and which covers most of the cross section area of the chamber, and which is designed in such a way that the oil, conveyed by the rotating transmission shaft, builds itself up at the catch and guide plate and under the pressure, by which the lubrication and cooling oil is pushed into the axially offset lubrication oil borehole.

An additional oil supply device, conveying lubrication and cooling oil into a rotating shaft, is known to the applicant by DE 39 27 775 C2 where two sealing rings are needed on the shaft, which are axially positioned, spaced from each other, whereby sealed locations are formed through two sealing surfaces, inside of the enclosure and positioned mainly radial at a distance from each other. Hereby, the sealing rings have a close contact with the sealing surfaces, due to the oil pressure which is present between the sealing rings. Furthermore, an oil supply connection is provided between the sealed locations in the enclosure, through which the oil flows into an oil receiving borehole in the shaft and between the sealed locations. The sealing effort is very large in that design and it results in a high manufacturing and assembly cost as well as in large spatial requirements.

An assigned rotary feed-through configuration for the oil supply of a multiple clutch device, wet running and/or hydraulically actuated, with at least two multi-disk configurations, is known to the applicant by DE 102 03618 A1 which has at least a stator section positioned, or to be positioned, on the transmission side, and at least a rotor section, turning with the clutch device, whereby the stator section, before integration with the clutch device in the drive train of the motor vehicle, can be linked to the rotor section to create an assembly which includes at least one rotary feed-through of the rotary feed-through configuration which includes the stator section and which can be mounted at the transmission enclosure, on the transmission side.

The rotary feed-through devices, known from the state of the art for the supply of shafts which have an axial extending borehole or an oil passage, respectively, overall are space intensive and cost intensive.

To convey pressure oil into the rotating shafts generally requires an axial installation space, which derives from the width from the two rectangular rings needed for the sealing, the shoulder width of the associated rectangular ring notches, and the width of the oil transfer notch. Based on the total amount of the axially needed installation space to create the rotary feed-through, and the needed axial installation space of the bearing base, in accordance with the basic design of a transmission, the resulting disadvantageous is the need for a totally large axial installation space, especially with regard to the sealing of the shaft and for the torque which needs to be transferred.

### SUMMARY OF THE INVENTION

It is the task of this invention to present a rotary feed-through, to supply the oil to a transmission shaft having an axial extending borehole or oil passage, respectively, through which the disadvantages of the rotary feed-through, known from the state of the art, are avoided. In particular, the inventive device guarantees an effective oil supply with low axial installation space requirements; the realization of the inventive rotary feed-through requires just the installation space for a basic transmission design.

Thus, a rotary feed-through is proposed, for oil supply to a shaft in an axial extending borehole or oil passage on which, viewed axially, a part is torque-proof positioned, for instance a fixed gear, a synchronous body or a claw type shift element, comprising a stator on the enclosure side and a rotor which rotates with the shaft, in which the fixed bearing cover or the holding plate of the bearing, respectively, of the shaft which needs to be supplied with oil, serves as the stator, and the hub of an already present, axial viewed at the side of the bearing facing away from the enclosure and positioned before the bearing and rotationally fixed linked with the shaft connected part, serves as the rotor of the rotary feed-through.

In accordance with the invention, the bearing cover which is functionally connected with the enclosure, preferably screwed together, accepts the pressure oil through the provided feed boreholes; within the scope of and as an additional, advantageous embodiment of the invention, the bearing cover has manufactured built-in receptacles, designed as rectangular rings, for the sealing parts, has fluidly connected feed boreholes provided in the enclosure, and has a fluidly connected, rotating oil transfer notch which is connected with the feed boreholes.

In addition, the hub of the part, positioned before the bearing, has the required design to accommodate the sealing parts, preferably designed as rectangular rings, on one hand, through the oil transfer notch and, on the other hand, through the fluidly connected feed boreholes for the oil, from the surface of the shaft into the axial extending borehole or oil passage extending boreholes, respectively.

The element, which is torque proof connected with the shaft, is preferably a fixed gear, a synchronous body of a synchronization or a claw shift element without a synchronization device.

For instance, a rotary feed-through can be provided for an automatic transmission to provide the main shaft with oil, in accordance with the invention, in which the holding plate of the fixed bearing serves as a stator, and the hub of the park lock gear serves as a rotor for the rotary feed-through.

Through the inventive conception of the integration of the rotary feed-through within the basic bearing part, a rotary feed-through is provided where the already available installation space is also sufficient. Furthermore, because already available parts, especially the bearing cover and, axially viewed, a fixed element positioned before the bearing on the shaft, will be used, the manufacturing and the assembly costs are reduced.

### BRIEF DESCRIPTION OF THE DRAWINGS

By the following, the invention is exemplarily explained further based on the included drawings. It shows:

FIG. 1 is a schematic sectional view in accordance with the inventive rotary feed-through for the oil supply of a shaft which has an axial extending borehole or oil passage, respectively; and

FIG. 2 is an enlarged detailed of the rotary feed-through for the oil supply in accordance with FIG. 1.

### DETAILED DESCRIPTION OF THE PREFERRED EMBODIMENTS

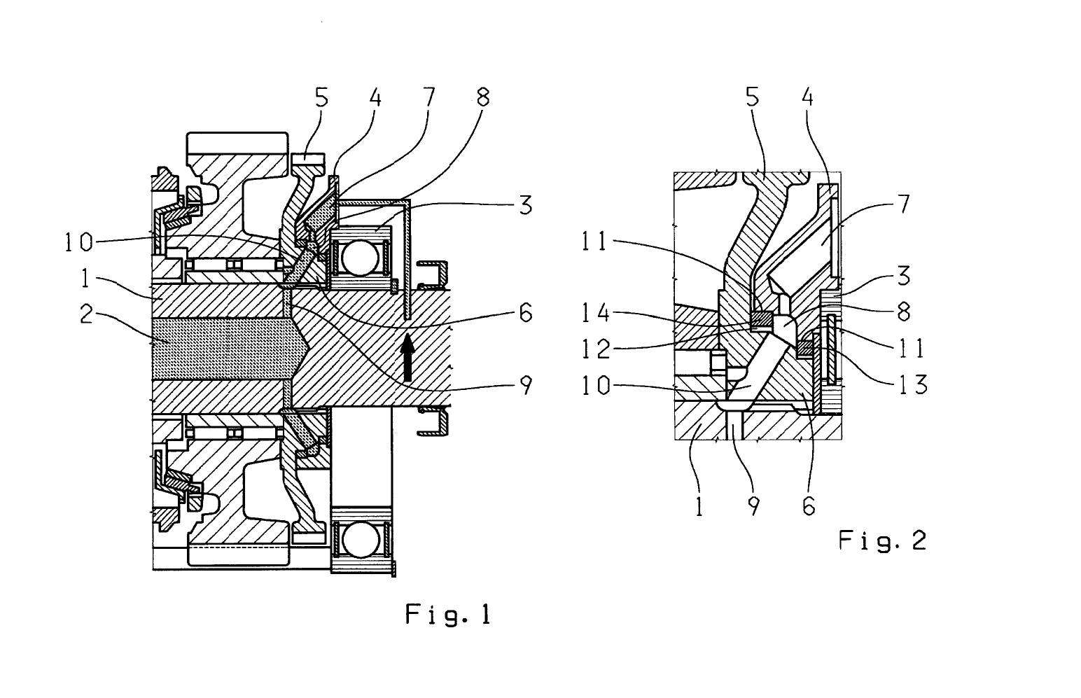

FIGS. 1 and 2 show a main shaft 1 of a transmission to be supplied with oil, which has an axially extending borehole or oil passage 2 and which is positioned at a fixed bearing 3, whose retaining plate or bearing cover, respectively, is labeled as 4. The bearing cover 4 is functionally linked (not shown) with an enclosure of the transmission. In addition, when viewed axially from the side facing away from the enclosure of the bearing 3, a park lock gear 5 is positioned, rotationally torque-free connected with the shaft 1, before the bearing cover 4.

In accordance with the invention, a rotary feed-through for the oil supply of shaft 1 comprising a stator, positioned on the enclosure side, and a rotor, rotating with shaft 1, is proposed in which the fixed position bearing cover 4 or the holding plate of the bearing 3, respectively, of the shaft 1 to be supplied with oil, designed as the stator, and the hub 6 of the already present part 5, designed as the park lock gear, when viewed axially, positioned before the bearing 3, at the side which is facing away from the enclosure of the bearing 3 and torque-free connected with the shaft 1, serves as the rotor of the rotary feed-through.

In accordance with the invention, through the provided feed holes in the enclosure side (not shown), the bearing cover 4 or the holding plate of the bearing 3, respectively, has fluidly coupled feed boreholes 7 for the pressure oil, and by means of the feed boreholes 7, a fluidly coupled circulating oil transfer notch 8 at the side which is facing the part 5.

As it can be seen in FIGS. 1 and 2, by means of the park lock gear 5 which is positioned before the bearing 3, the hub 6 has for the oil, on one hand, via the oil transfer notch 8 and, on the other hand, via the fluidly coupled feed boreholes 10 into the boreholes 9 in the surface of shaft 1 and axial extending boreholes or the oil passage 2, respectively.

Thus, as it is made clear by the arrow and the hatched marked area in FIG. 1, the conveyed oil is preferably forced by an internal oil transmission pump, through the provided feed boreholes in the enclosure, the provided feed boreholes 7 in the bearing cover 4, the oil transfer notch 8, the provided feed boreholes 10 in the hub 6 of the park lock gear 5, and the feed boreholes 9, into the borehole or oil passage 2 of the shaft 1.

In accordance with the invention and referring to FIG. 2, the bearing cover 4 or the holding plate of the bearing 3, respectively, and the hub 6 of the park lock gear 5 have required axial and/or radial holding devices or circular notches 11, 12, respectively, to accommodate a sealing part of the rotary feed-through, preferably designed as rectangular rings 13, 14.

### REFERENCE CHARACTERS

1 Shaft, to be supplied with Oil
2 Oil passage of shaft 1
3 Fixed bearing
4 Bearing cover
5 Parking lock gear
6 Hub
7 Feed borehole
8 Oil transfer notch
9 Borehole
10 Feed borehole
11 Circular Notch
12 Circular Notch
13 Rectangular ring
14 Rectangular ring

1-6. (canceled)

7. A rotary feed-through, for supplying oil to one of an axial extending borehole and an oil passage (2) of a transmission shaft (1), comprising:
a stator positioned at an enclosure,
a rotor which rotates together with the transmission shaft (1),
a bearing cover (4), connected with one of the enclosure and a holding plate of a bearing (3) for the transmission shaft (1) to be supplied with oil, and the bearing cover (4) serves as the stator, and
an already present hub (6), when viewed axially from the side of the bearing (3) facing away from the enclosure and positioned before the bearing (3) and rotationally fixed connected part (5) and linked with the shaft (1), serves as the rotor of the rotary feed-through.

8. The rotary feed-through for supplying oil to one of the axial extending borehole and the oil passage (2) of a transmission shaft (1) according to claim 7, wherein one of the bearing cover (4) and the holding plate of the bearing (3) is provided with feed boreholes (7) for supplying oil and the feed boreholes (7) are fluidly connected with a rotating oil transfer notch (8), and
the hub (6) of the part (5), positioned before the bearing (3), has feed boreholes (10) which communicate, on one hand, with the oil transfer notch (8), on the other hand, with the extending boreholes (9) in the surface of the transmission shaft (1) and one of the axially extending borehole and the oil passage (2).

9. The rotary feed-through for supplying oil to one of the axial extending borehole and the oil passage (2) of a transmission shaft (1) according to claim 7, wherein one of the bearing cover (4) and the holding plate of the bearing (3) and the hub (6) of the part (5) each have one of an axial holding device, a radial holding device and a circular notch (11, 12) for accommodating a sealing part (13, 14) of the rotary feed-through.

10. The rotary feed-through for supplying oil to one of the axial extending borehole and the oil passage (2) of a transmission shaft (1) according to claim 9, wherein each sealing part (13, 14) of the rotary feed-through is a rectangular ring.

11. The rotary feed-through for supplying oil to one of the axial extending borehole and the oil passage (2) of a transmission shaft (1) according to claim 7, wherein the part (5) is one of a fixed gear, a synchronous body of a synchronization and a claw clutch part without a synchronization device.

12. The rotary feed-through for supplying oil to one of the axial extending borehole and the oil passage (2) of a transmission shaft (1) according to claim 7, wherein the shaft (1), to be supplied with oil, is a main shaft of an automatic transmission and the part (5) is a park lock gear.
